(19) United States
(12) Patent Application Publication
(10) Pub. No.: US 2026/0153378 A1
(43) Pub. Date: Jun. 4, 2026

(54) DISTRIBUTED ACOUSTIC SENSING (DAS) FOR EVENT DETECTION MONITORING

(71) Applicant: Precise Downhole Services Ltd., Nisku (CA)

(72) Inventors: Hossein Izadi, Edmonton (CA); Murtaza Rampurawala, Edmonton (CA); Aleksei Andriianov, Edmonton (CA); Daniel Keough, Edmonton (CA); Michael Melnychuk, Edmonton (CA)

(21) Appl. No.: 19/408,647

(22) Filed: Dec. 4, 2025

Related U.S. Application Data
(60) Provisional application No. 63/728,019, filed on Dec. 4, 2024.

(51) Int. Cl. G01H 9/00; E21B 47/107; E21B 47/135; G01D 5/353

(52) U.S. Cl. CPC G01H 9/004; E21B 47/107; E21B 47/135; G01D 5/35361

(57) ABSTRACT

Disclosed examples generally relate to a method and system for using DAS for event monitoring. In some examples, the method involves analyzing at least one backscattered optical signal generated by a DAS system, to determine at least one optical-signal property, wherein the at least one backscattered optical signal is generated in response to at least one interrogating optical signal transmitted through a fiber-optic cable extending within the downhole well; identifying, based on the at least one optical-signal property, the occurrence of an acoustic event within the downhole well at a given depth location; and generating an output associated with the acoustic event.

### CROSS-REFERENCE TO RELATED APPLICATION(S)

This application claims the benefit under 35 U.S.C. § 119 (e) of U.S. Provisional Patent Application No. 63/728,019, filed Dec. 4, 2024, the entire disclosure of which is hereby incorporated by reference.

### FIELD

The disclosed examples generally relate to using distributed acoustic sensing (DAS) systems, and in particular, to a method and system for using DAS for event monitoring. In some examples, the method and system are applied in various oil and gas related applications. Further, disclosed examples may be applied in real-time or near real-time.

### BACKGROUND

A variety of tools have been previously developed to assess well integrity, in downhole wells. These tools include temperature logs, density or hold-up logs, acoustic logs, resistivity tools, pressure measurements, and spinner flow meters. By integrating multiple tools into a single tool string, operators can obtain a comprehensive view of well integrity assessments and gas leakage detection. However, traditional methods face limitations, such as the reliance on wireline or coiled tubing, which can lead to significant delays and increased health, safety, and environmental (HSE) risks. These methods can also be intrusive, potentially disturbing normal operations, and are often constrained by size restrictions and limited measurement periods.

### SUMMARY

In at least one broad aspect, there is provided a method for using distributed acoustic sensing (DAS) for event monitoring in a downhole well, the method comprising: analyzing at least one backscattered optical signal generated by a DAS system, to determine at least one optical-signal property, wherein the at least one backscattered optical signal is generated in response to at least one interrogating optical signal transmitted through a fiber-optic cable extending within the downhole well; identifying, based on the at least one optical-signal property, the occurrence of an acoustic event within the downhole well at a given depth location; and generating an output associated with the acoustic event.

In another broad aspect, there is provided a system for distributed acoustic sensing (DAS)-based acoustic event monitoring in a downhole well, the system comprising: a fiber-optic cable configured to be deployed within the downhole well; an DAS unit configured to transmit the at least one interrogating optical signal through the fiber-optic cable and to receive at least one backscattered optical signal generated in response thereto; and a memory storing computer-executable instructions which, when executed by at least one processor, cause the at least one processor to execute the method comprising: analyzing the at least one backscattered optical signal generated by a DAS unit, to determine at least one optical-signal property; identifying, based on the at least one optical-signal property, the occurrence of an acoustic event within the downhole well at a given depth location; and generating an output associated with the acoustic event.

In some examples, the method is performed in real time or near real time.

In some examples, the fiber-optic cable extends along a casing structure extending into the downhole well.

In some examples, the at least one optical-signal property comprises at least one time-domain optical-signal property and/or at least one frequency-domain optical-signal property, which is associated with the backscattered optical signal.

In some examples, the method further comprises: determining a target acoustic event for monitoring; identifying at least one reference acoustic signature associated with the target acoustic event; analyzing the at least one optical-signal property at different depths in the downhole well to determine the presence of the at least one reference acoustic signature; and if the at least one reference acoustic signature is identified at a given depth, generating a corresponding output of the presence of the acoustic event at that depth.

In some examples, the backscattered optical signal is analyzed for predefined optical-signal properties, associated with the acoustic event, and the method further comprises: comparing the predefined optical-signal properties to a corresponding at least one reference acoustic signature.

In some examples, the at least one reference acoustic signature for a given event comprises (i) at least one reference time-domain optical-signal property, and/or (ii) at least one reference frequency-domain optical-signal property, indicative of the acoustic event.

In some examples, the reference frequency-domain optical-signal property comprises a frequency response in at least one frequency band comprising: (i) a low-band frequency range, (ii) a mid-based frequency range, (iii) a mid-high-band frequency range, and (iv) a high-band frequency range.

In some examples, the at least one frequency band comprises, (i) the low-band frequency range from about 0 Hz to about 10 Hz, and preferably, about 2.4 Hz to about 4.9 Hz; (ii) the mid-band frequency range from about 11 Hz to about 300 Hz, and preferably, about 30 Hz to about 130 Hz; (iii) the mid-band frequency range from about 301 Hz to about 1035 Hz, and preferably, about 490 Hz to about 1035 Hz; and (iv) the high-band frequency range from about 1036 Hz to about 5,000 Hz, and preferably, about 1036 Hz to about 4990 Hz.

In some examples, the target acoustic event comprises surface casing vent flow (SCVF) and/or gas migration, and the event demonstrates higher frequency responses in the mid-band, than the mid-high and high bands.

In different embodiments, the present invention may comprise a method or system comprising any combination of elements or features described herein, or which specifically omits any particular feature or element described herein.

### BRIEF DESCRIPTION OF THE DRAWINGS

In the drawings, like elements may be assigned like reference numerals. The drawings are not necessarily to scale, with the emphasis instead placed upon the principles of the present disclosure. Additionally, each of the embodiments depicted are but one of a number of possible arrangements utilizing the fundamental concepts of the present disclosure.

FIG. 1 is an example system for acoustic event monitoring using distributed acoustic sensing (DAS).

FIG. 2 is an example DAS system, incorporating a DAS unit and a fiber-optic cable.

FIG. 3A is example method for using distributed acoustic sensing (DAS) for event monitoring applications.

FIG. 3B is an example method for automated acoustic event detection.

FIGS. 4-7 exemplify various output visualizations that are generated from data processing analysis.

FIG. 8 is an example hardware configuration for a computing server.

### DETAILED DESCRIPTION

Examples herein generally relate to methods and systems for using distributed acoustic sensing (DAS) for event monitoring.

### I. DEFINITIONS

Any term or expression not expressly defined herein shall have its commonly accepted definition understood by a person skilled in the art. As used herein, the following terms have the following meanings.

“Acoustic event” refers to any physical phenomenon (e.g., in or around a downhole well) that generates a detectable acoustic or vibration-induced response along a fiber-optic cable forming part of a distributed acoustic sensing (DAS) system. In the context of downhole wells, acoustic events may include gas leaks, gas migration, sustained casing-vent flow (SCVF), fluid movement, equipment operation, or other mechanical or flow-related activity.

“Distributed Acoustic Sensing (DAS)” refers to a technology that uses optical fibers as sensors to detect and monitor acoustic signals along their length.

“Gas migration” refers to the flow of formation gas outside the surface casing of a well, moving upward through the surrounding annulus or adjacent geologic pathways. It can result from breaks, leaks, or corrosion perforations in a well casing that allow formation gas to escape into the annulus outside the casing and migrate upward.

“Parallelized computing processing” refers to dividing a computational task into smaller sub-tasks that can be executed simultaneously across multiple processors or cores. This approach increases efficiency and speed, especially for complex or large-scale problems, by leveraging the capability of modern multi-core or distributed systems.

“Predefined” refers to a value, threshold, condition, or data structure or otherwise that is specified in advance and may be, for example, stored in system memory for later retrieval and use during operation.

“Real time or near real time” means actions or processes performed either instantaneously after receiving specific inputs, or within a very short timeframe, typically measured in seconds (e.g., within 0.0001 to 5 seconds).

“Reference” means any predefined data, rule, or parameter maintained, for example, in system memory that serves as a comparative baseline.

“Surface Casing Vent Flow (SCVF)” refers to the uncontrolled flow of formation gas or fluid to surface through the surface-casing vent assembly, typically occurring along the annular space behind the surface casing of a well. SCVFs may arise from factors such as inadequate cement sealing, casing or component failure, or other conditions that allow downhole hydrocarbons to migrate upward.

### II. General Overview

Surface casing vent flow (SCVF) and gas migration can develop at certain oil or gas wells due to flaws in well seals. These flaws may arise from drilling or cementing conditions or from outdated construction methods used on older wells that do not meet modern standards.

To date, technology for real-time monitoring of SCVF has traditionally relied predominantly on acoustic logging tools and data. However, with the rise of distributed sensing technology over the past decade, the use of distributed fiber optic sensing (DFOS) for quantitative disturbance profiling has gained significant traction. It is believed that the application of distributed acoustic sensing (DAS) technology for gas leak detection has the potential to greatly improve the accuracy and reliability of well integrity monitoring.

DAS offers several advantages over traditional methods for downhole acoustic monitoring. For example, DAS technology allows for acquiring high-resolution acoustic data along the wellbore, offering detailed insights into the acoustic signatures linked to potential gas leaks. Further, once the fiber is deployed in the well, it eliminates the need for well interventions, significantly reducing HSE (health, safety and environmental) risks.

Additionally, DAS systems offer versatility across the entire well lifecycle—from hydraulic fracturing to continuous integrity and production monitoring—and can reduce costs when interrogators are shared across multiple wells. Continuous data acquisition, combined with cloud-based platforms, also enables real-time surveillance and decision-making that supports improved production optimization.

Despite these advancements, the implementation of DAS technology presents several challenges. These challenges include:
Data Storage and Management: DAS systems can produce substantial amounts of data; for example, a single minute of DAS recording typically generates around 1 GB of data. This makes processing the data resource intensive. Particularly, it is difficult to process this volume of data efficiently in real time or near real time. This presents challenges in applying DAS for real time or near real time event monitoring.
Applications and Processing: DAS technology has numerous applications. The variety of applications complicates configuration, processing, and storage needs. To that end, existing DAS systems may not automatically detect events (e.g., gas leak events) based on data analysis, and may otherwise rely primarily on the operator's interpretation of the output data.
Interoperability: Enhancing the value of DAS data involves integrating it with other systems, such as Distributed Temperature Sensing (DTS). Ensuring that DAS data is compatible with various file formats used in oilfield applications is therefore essential.

Accordingly, disclosed examples provide methods and systems for real time, or near real time acoustic event monitoring, using a DAS system.

In at least one example, disclosed embodiments are used for well integrity monitoring. For example, they can provide for a real-time, quantitative approach to SCVF monitoring using DAS. This, in turn, enhances decision-making strategies related to well integrity and management, marking a significant advancement in oil and gas monitoring practices.

The developed integrated workflow may also allow for the acquisition of detailed acoustic data along the wellbore, providing precise identification and quantification of potential gas leak intervals.

As provided herein, described examples are not limited to only well integrity monitoring. For example, they may also be used as well for oil and gas production monitoring. This includes direct production monitoring, as well as evaluation of downhole equipment performance in terms of production capabilities. For instance, disclosed examples can enable monitoring the performance of downhole facilities during production, including performance of electric submersible pumps (ESPs) and gas lift systems in real time, and identifying potential declines in efficiency. Examples herein also provide for noise logging in abandoned wells.

### III. Example System

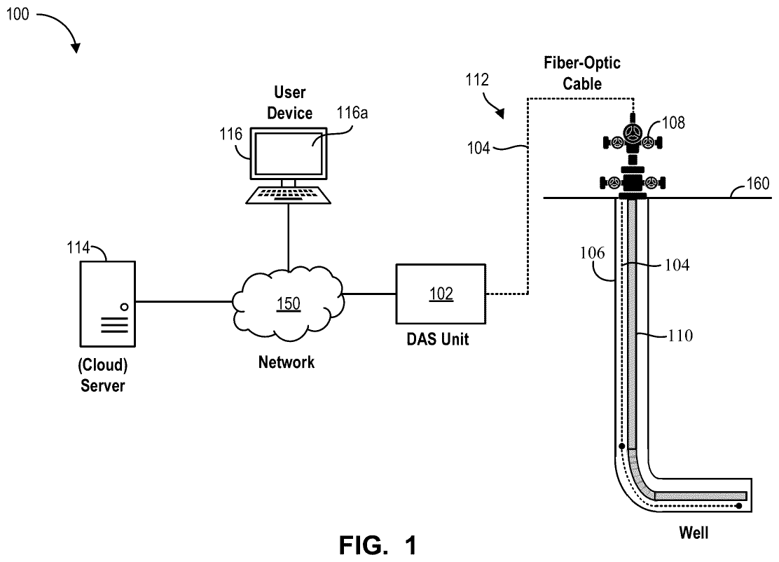

FIG. 1 shows an example system 100 for acoustic event monitoring using distributed acoustic sensing (DAS).

As shown, the system 100 includes a distributing acoustic sensing (DAS) unit 102, as known in the art. DAS unit 102 can couple, via communication network 150, to one or more of a server 114 and a computer terminal 116.

Communication network 150 can be an internet, or intranet network and can be wired or wireless. In some examples, network 150 may be connected to the internet.

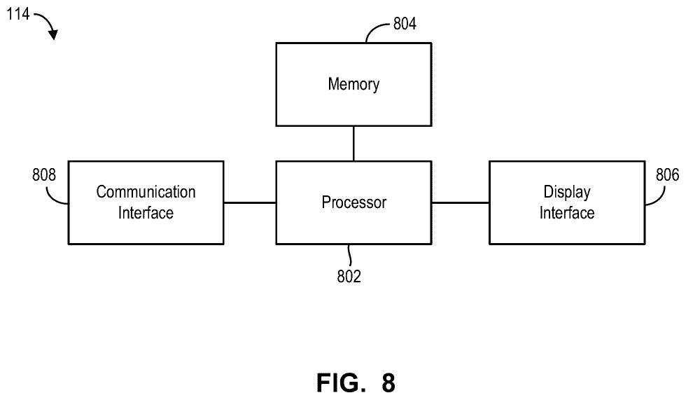

As shown in FIG. 8, and explained herein, server 114 can include a processor 802 coupled to one or more of a memory 804, display interface 806 and a communication interface 808. As with all devices shown in the system 100, there may be multiple servers 114, although not all are shown. As explained herein, server 114 can be used for various data processing functionalities.

Additionally, server 114 need not be a dedicated physical computer. For example, server 114 can be a “cloud server”. In some examples, the various logical components that are shown as being provided on server 114 may be hosted by a third party “cloud” hosting service.

User device 116 can be a computer, laptop, phone or the like. In some examples, user device 116 includes a display interface 116a for displaying various output visualizations, as discussed below. Similar to server 114, user device 116 may include a processor, volatile and non-volatile memory, at least one network interface, and may have various other input/output devices.

DAS unit 102 is further coupled to one or more fiber-optic cables 104. The DAS unit 102 and the associated fiber-optic cable(s) 104 can collectively define a DAS system 112, or DAS assembly 112.

In at least one example application, the fiber-optic cables 104 are disposed inside a downhole well 106. Well 106 may be an oil or gas well that extends through a subsurface formation 160. As shown, the well 106 may include a well head 108 and one or more conveyance structures 110 (e.g., a tubing and/or casing) extending therethrough.

Fiber-optic cable 104 may be disposed in any location relative to, or inside, well 106. For example, the fiber-optic cable 104 may be attached to the conveyance structure 110 and may run along any portion of the length thereof. It may also run inside or outside the conveyance structure 110. In some cases, the fiber optic cable 104 extends through the wellhead 108 (or generally from above the well 106), and extends to various depths inside the well 106.

To monitor SCVF or gas migration, the fiber-optic cable 104 may be deployed along all or part of the length of a well casing 110 (e.g., production, outer, or surface casings), and either inside or outside the casing. In some implementations, the cable extends through the wellhead 108 (or generally from the well surface) and continues below ground to selected depths, running alongside any desired portion of the casing(s). This configuration may position the fiber-optic cable 104 adjacent to the annular region where SCVF or gas-migration pathways occur, allowing the DAS system to detect the acoustic signatures generated by leaking or migrating gas and to localize the depth of the activity.

In other example applications, the DAS system 112 is used for well-integrity monitoring. In still other examples, it is used for production monitoring, including direct production monitoring, as well as evaluation of downhole equipment performance in terms of production capabilities. The DAS system 112 can also be used for noise logging in abandoned wells, or various applications in pipeline monitoring.

More broadly, the fiber-optic cable 104, in DAS system 112, is disposed in, and/or coupled to, any target monitoring structure or environment, that is desired to be monitored (e.g., a downhole well casing or a pipeline).

While not explicitly illustrated, in FIG. 1, various other fiber-optic cables may also run downhole. This includes fiber cables associated with distributed temperature sensing (DTS) systems, as known in the art. It is also possible that the same DAS unit 102 is coupled to different fiber-optic cables running through different downhole wells, or positioned along different target structures.

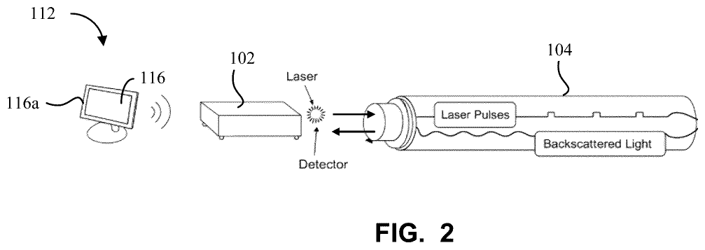

FIG. 2 shows an example DAS system 112, incorporating the DAS unit 102 and the fiber-optic cable 104.

DAS unit 102 may include components such as a laser source configured to generate interrogation optical pulses, an optical transmitter for launching the pulses into the fiber 104, and one or more photodetectors for receiving the backscattered light returned from the fiber. The DAS unit can also include signal-conditioning and data-acquisition circuitry, timing and synchronization modules, and a processing module programmed to analyze the backscattered optical signals to derive the optical-signal properties.

To this effect, a conventional DAS system 112 uses optical fibers as sensors to detect and measure vibrations, sound waves, or acoustic signals along the length of the fiber. DAS technology works by operating the DAS unit 102 to generate and transmit laser pulses (e.g., interrogation optical laser signals) through the fiber 104 and analyzing the backscattered light (e.g., backscattered optical signals). The backscattered light is analyzed to detect and measure changes in the response (e.g., amplitude, phase, etc.). Particularly, changes in the backscatter wave pattern may be caused by external disturbances, which allows the system to determine the location and characteristics of the event.

In some cases, DAS allows for high-resolution sampling along the optic fiber, achieving spatial resolutions as low as 1.25 meters and sample rates up to 20 kHz.

Various types of optical-fiber cables 104 can be used in the DAS system 112, including both single mode fibers and/or multi-mode fibers.

As shown in FIG. 2, the resulting backscattered optical signal data can be displayed on a display interface 116a of a user computer 116, coupled to the DAS unit 102.

As disclosed herein, the response backscattered optical signal data—received by the DAS unit 102—is analyzed (e.g., on the server 114 and/or DAS unit 102). The backscattered optical signal data can be analyzed to determine the presence of acoustic signatures associated with various downhole events. These include gas leak detection and fault detection. In examples involving production monitoring, the detected events also relate to production monitoring.

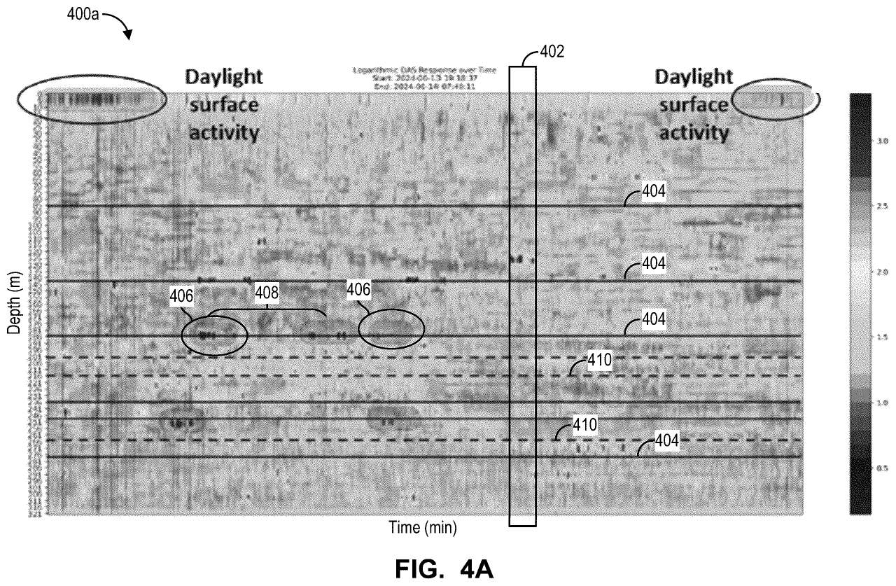

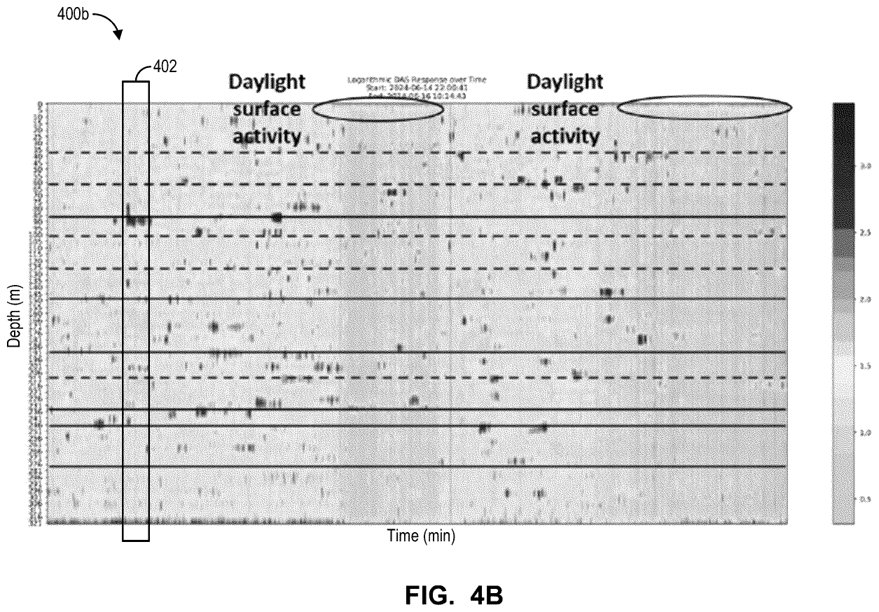

Based on the data analysis, various visualizations (FIGS. 4-7) may be generated, and updated in real time or near real time. These visualization may be output on display interface 116a of terminal 116. In some example applications, these visualizations can assist operators in promptly understanding the impact of certain adjustments made by downhole operations, on well condition.

Referring back to FIG. 1, it is possible that the DAS unit 102 is an all-integrated system that includes the data processing functionality of the server 114 and/or computer terminal 116. In this manner, reference herein to server 114 and/or computer terminal 116 executing a specific function may be understood to include the DAS unit 102 performing that same function.

To this end, the system architecture for the server 114 (FIG. 8) is also reflective of the architecture of the DAS unit 102 (e.g., including a processor coupled to one or more of a memory and communication interface).

### IV. Example Method(S)

The following are various example methods 300a, 300b for using DAS for event detection monitoring. Methods 300a, 300b may be executed by at least one processor, such as the processor 802 of server 104. These methods may be applied in real time, or near real time.

### (i.) General Method.

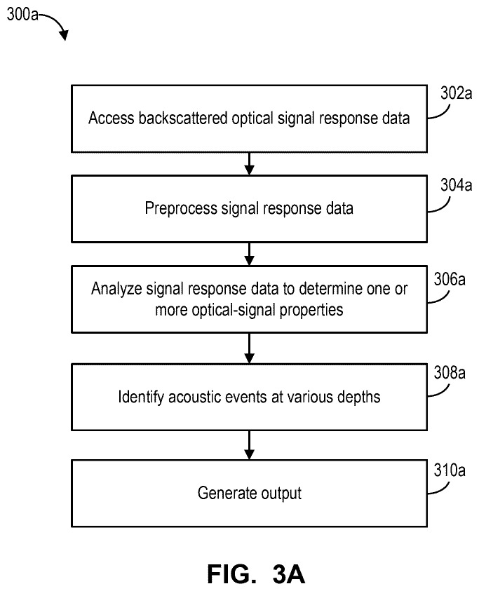

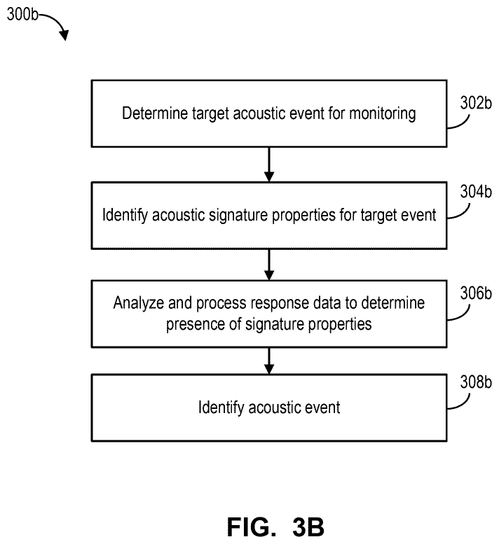

FIG. 3A shows a process flow for an example method 300a for using distributed acoustic sensing (DAS) for monitoring applications.

At 302a, at least one backscattered optical signal is acquired from the DAS system 112. In operation, the DAS unit 102 generates and transmits interrogating optical signal(s) (e.g., pulses) through the fiber-optic cable 104 and receives the resulting backscattered optical signal(s).

In at least one example, the data file containing the signal response data is stored as data file (e.g., an HDF5 file). Accordingly, at 302a, the system monitors for new data files containing sensed data, and reads the matrices contained in that file. A watchdog library may be used to automatically detect new files in specified directories. The monitoring of new data files in real time or near real time, allows for corresponding real time or near real time processing.

In some examples, the data is accessed in real time or near real time. In other examples, the data files containing the signal response data are accessed after the fact for post-processing. For instance, the data files may be stored in memory and later retrieved for deferred analysis.

At 304a, the signal response data is pre-processed. For example, this can include analyzing the data to extract metadata, including matrix dimensions, timestamps and spatial sampling rates. The pre-processing may also involve extracting the raw signal data, e.g., at 16-bit integers or floating-point values.

In at least one example, as part of the processing at 304a, large data files (e.g., HDF5 files) containing the response signal data are initially segmented into smaller files. Segmenting the data in this manner facilitates real-time analysis, as the smaller files allow for more efficient memory usage and computation. For instance, the data may be partitioned into files representing five-second time increments. In other cases, instead of segmenting the files, the system simply accesses the data at act 302a in frequent intervals (e.g., every five seconds), ensuring that only a small portion of the data is processed at any given moment.

This segmented or interval-based approach provides a technical advantage that is not apparent from conventional DAS processing workflows. Traditional DAS systems often process continuous, unsegmented data streams or large monolithic files, which require substantial memory allocation and sustained computational throughput. In contrast, by limiting analysis to smaller, time-bounded data portions, the system reduces the amount of data loaded into memory at any given moment and minimizes the number of operations required for each processing cycle. This produces faster response times, lowers computational overhead, and enables real-time or near real-time analysis in environments where conventional full-file processing would be impractical.

At 306a, the signal-response data (e.g., raw and/or preprocessed) is analyzed to determine at least one optical-signal property at various depths along the downhole well (e.g., all or some of the depths).

In some examples, the optical-signal properties include time-domain and/or frequency-domain properties, as well as more broadly, any other measurable or inferable features of the signal, individually or in combination with other parameters.

“Time-domain optical-signal properties,” as used herein, refer to characteristics of the signal evaluated as a function of time. Such properties may include, without limitation, amplitude average and/or peak, phase, waveform shape, rise time, fall time, event duration, energy, repetition interval, zero-crossing rate, temporal derivatives (e.g., rate of change of amplitude), and statistical descriptors of the signal over time (e.g., root-mean-square amplitude, crest factor, skewness, or kurtosis). Time-domain properties accordingly characterize how the signal evolves or varies within the time domain.

“Frequency-domain optical-signal properties,” as used herein, refer to characteristics of the signal evaluated as a function of frequency, typically obtained through a Fourier transform or other spectral-analysis technique. Such properties may include, without limitation, spectral amplitude, power spectral density, dominant frequencies, spectral bandwidth, harmonic content, spectral centroid, spectral flatness, spectral roll-off, spectral entropy, and distributions of spectral energy across one or more frequency bins. Frequency-domain properties characterize how the signal's energy is distributed across frequencies.

Optical-signal properties may also include the above-noted properties, expressed on any suitable scale (e.g., normalized and/or logarithmic forms of these properties).

At 308a, based on the optical-signal properties, the system identifies any acoustic events, e.g., occurring within the downhole well. This may also involve determining the depth location, along the downhole well, where the acoustic event was identified.

The acoustic events detectable may include well-integrity related activity such as gas leaks, gas migration, and sustained casing-vent flow (SCVF). These events often produce characteristic acoustic signatures that are observable in the DAS signal response and can be localized along the wellbore. As described above, the deployment of the fiber-optic cable 104 along the well casing positions the sensing fiber adjacent to regions where

SCVF or gas-migration pathways may occur, enabling the DAS system to capture the acoustic response and determine the depth of the activity.

Additional examples of detectable acoustic events include production-related flow activity, tubing or casing leaks, valve or pump actuation, fluid movement in the annulus or formation, and mechanical noise associated with downhole equipment performance.

The method for identifying the acoustic events, based on the optical-signal properties, is described below in method 300b.

The analysis at 308a may also involve determining the depth location(s), along the wellbore, at which the acoustic event was detected. Depth localization may be performed using conventional DAS techniques. Because the interrogating optical pulses travel along the fiber at a known propagation speed, and because the backscattered light received by the DAS unit is associated with specific positions along the fiber, the DAS system can map each measurement channel to a corresponding depth.

In some instances, by examining variations in optical-signal properties along those channels, the system identifies the channel (or group of channels) exhibiting the acoustic anomaly. The corresponding mapped depth is then assigned as the depth of the acoustic event. Depth resolution may be further refined using channel interpolation, matched-filtering, or frequency-based localization techniques known in the art.

At 310a, one or more outputs are generated in association with the detected acoustic event. The output may include, for example, the type of acoustic event (e.g., gas leak), the associated depth, and/or the intensity of the event.

The present disclosure is not limited to the type or form of output. In at least one example, the output includes a reduced-size file (e.g., a binary .dat file) containing parameters such as the signal-matrix dimensions, raw acoustic data, and associated metadata (e.g., timestamps and spatial sampling intervals). This file format may achieve significant size reduction (e.g., up to 500:1) relative to a standard output file (e.g., an HDF5 file), thereby simplifying storage (e.g., in cloud environments) and transfer.

The output at 308a can also comprise various plots and other graphical visualizations. These graphical outputs can be displayed, for instance, on a display interface 116a of the computer terminal 116.

FIGS. 4-7 exemplify various output visualizations that are generated from the analysis.

FIGS. 4A and 4B show example output heatmaps 400a, 400b of the logarithmic DAS phase amplitude response as a function of distance and time, for a first well (FIG. 4A) and a second well (FIG. 4B). The plots are generated over a time span of two or three days, and as a result of multiple interrogations by the DAS system through a fiber-optic cable.

As shown, the plots show the phase amplitude as a function of depth over the well 106, for different time instances 402. In each time instance 402, the corresponding visualization is generated by running a new iteration of the method 300a.

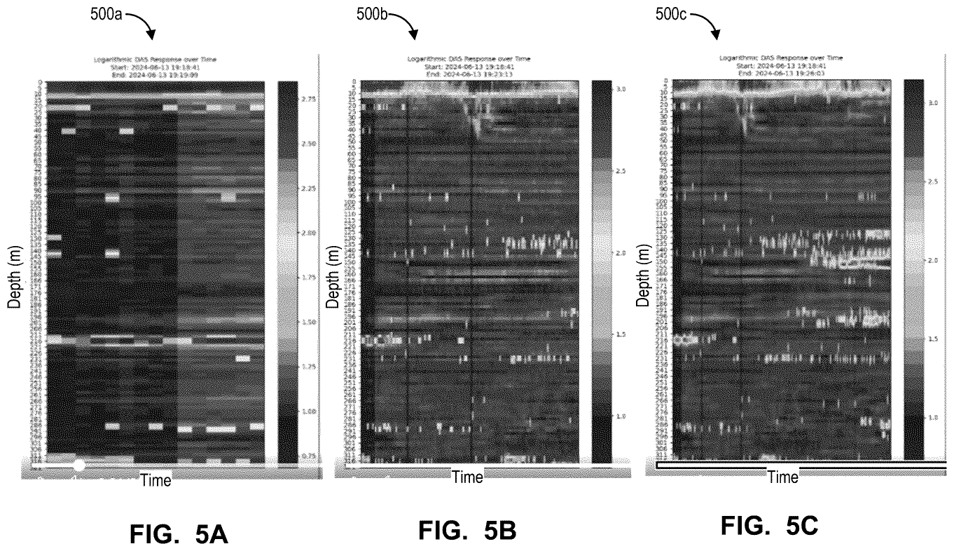

The system can automatically update the visualization (e.g., in real time or near real time) to include data received in each new time instance 402, or a new iteration of method 300a. This is exemplified in FIGS. 5A-5C, which show plots 500a-500c generated at incremental time instances and with updated cumulative response data over time. Accordingly, the plots update over time to provide a cumulative view for the operator at each depth.

Custom color scales may be used to enhance signal clarity and highlight significant changes. The various colors can indicate the amplitude response at different depths, at a given time instance.

More broadly, the visualizations in plots 400-500 enable an operator to manually determine the position (e.g., depths) of certain target events. In the exemplified plots, the target event involves a detected gas leak. As shown in FIG. 4A, the solid lines 404 represent depth positions where an acoustic event is detected. These are depths where the time-domain optical-signal properties 406 (e.g. logarithmic amplitude) are above a pre-defined threshold, and repeat at a set periodic interval 408. Depths indicated by a dashed line 410 signify depths where a potential gas leak is detected.

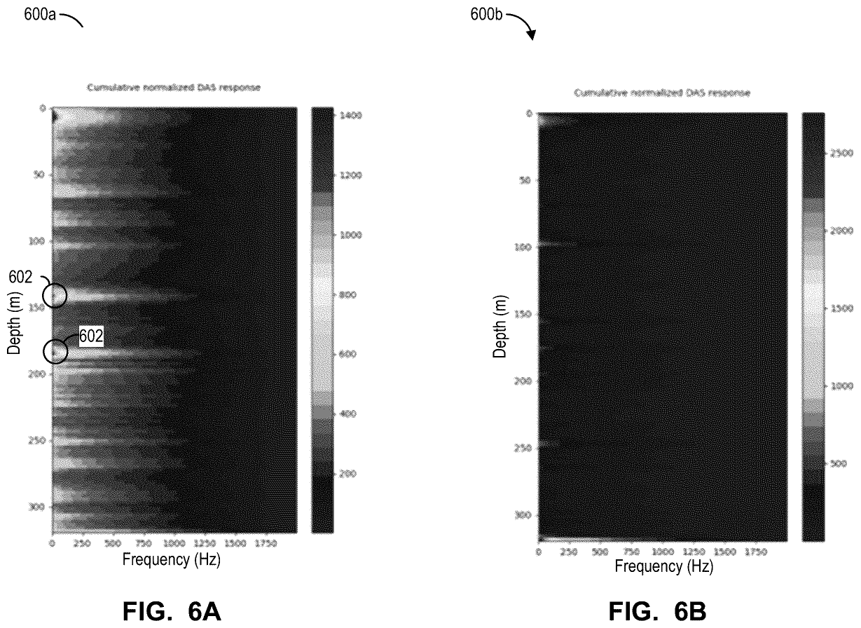

FIGS. 6A-6B show another example where the output comprises bar charts 600a, 600b of the cumulative frequency response at different depth positions for a first well (FIG. 6A) and a second well (FIG. 6B).

The bar charts 600a and 600b represent cumulative, normalized frequency responses across depth intervals. At each time instance, the method 300a is performed, and the frequency response determined at act 306a is monitored. The bar charts 600a and 600b cumulatively overlay the frequency-response data across successive time instances at each depth for each iteration of method 300a. Regions 602 exhibiting unexpected or elevated frequency responses can indicate depth locations at which an acoustic event is detected.

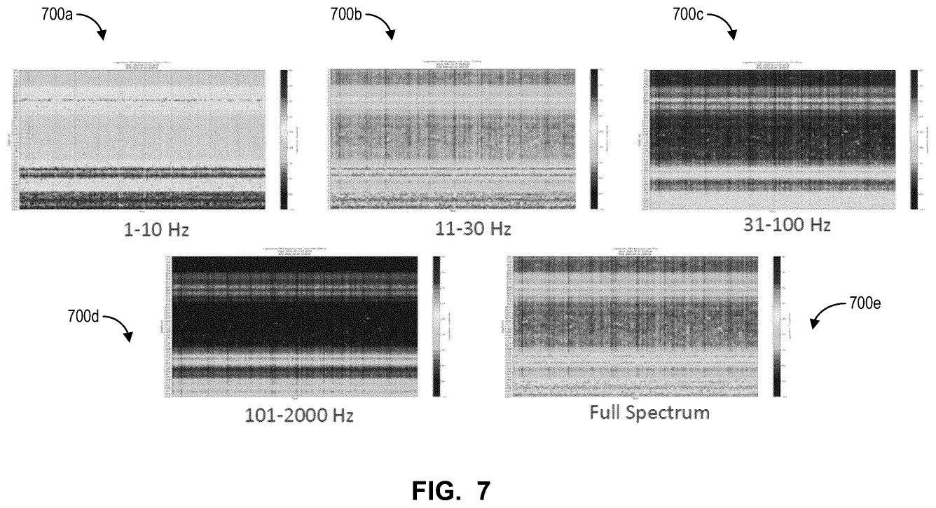

FIG. 7 also exemplify visualizations of frequency band extraction (FBE) plots 700a-700e for different frequency ranges. The raw signals are processed to separate and analyze different frequency components. This allows for patterns to be realized within the data.

Accordingly, the plots exemplified in FIGS. 4-7 provide real time, or near real time, visualization of the response within the monitoring target (e.g., well, pipeline, etc.). This allows the operator to quickly identify trends and anomalies. The real-time visualization capabilities allow for enhancing operational efficiency and aid in rapid decision-making processes in response to detected events.

In at least one example, the system generates a graphical user interface that allows users to: view real-time visualizations, adjust visualization parameters (e.g., frequency bands, depth ranges), save plots as high-resolution images (e.g., .png, .pdf) for reporting. The interface integrates seamlessly with the processing and visualization pipeline, ensuring a user-friendly experience.

To this effect, the real time processing is enabled by a number of factors including, (i) processing smaller sizes of output data for efficient memory handling; and (ii) in some examples, using parallel computational processing to allow for scalable performance, for extended monitoring and high sampling rates.

### (ii.) Method for Automated Event Detection

FIG. 3B shows a process flow for an example method 300b for automated event detection. Method 300b may be performed during act 308a, of method 300a.

As shown, at 302b, a determination is made in respect of a target acoustic event to monitor. The target event will vary based on the specific application. For example, for well integrity monitoring, the target event may relate to a gas leak. More broadly, the target event may comprise a gas flow or casing vent disturbance. For production monitoring, the target event can relate to evaluation of downhole equipment performance, such as performance of ESP or gas lift systems.

In some examples, the target event is user selected. For example, the user can select a target event using the computer terminal 116.

At 304b, the system can identify one or more reference acoustic signatures associated with the target acoustic event.

As used herein, “predefined” or “reference” acoustic signatures are previously established optical-signal properties (e.g., time-domain and/or frequency-domain optical-signal properties) associated with, and indicative of, the target acoustic event. These reference properties may be expressed in any suitable scale (e.g., normalized and/or logarithmic). The reference signatures are used as benchmarks for identifying that acoustic event.

The reference time-domain portion of acoustic signatures may include various reference time-domain optical-signal properties associated with the event. For example, different target events may express minimum peak amplitude properties. The time-domain acoustic signatures may also indicate that specific peak amplitudes should extend for a minimum duration of time and/or repeat at predefined recurring interval of time.

For instance, as illustrated in FIG. 4A, a target event may be characterized by the peak of its logarithmic amplitude response exceeding a predefined threshold 406. In addition, the acoustic signature may indicate that this elevated peak amplitude occurs at a recurring or periodically repeating interval 408. In some implementations, such recurring intervals are identified by evaluating cumulative time-series data and determining whether the peak amplitude rises above the threshold more than once over time in a manner consistent with a repeatable temporal pattern.

The frequency-domain portion of an acoustic signature may reflect reference frequency-domain optical-signal properties associated with the event. These include reference dominant frequencies, characteristic spectral patterns, or broadband energy increases that are indicative of the event.

To that end, it has been appreciated that certain downhole events have frequency response properties in specific frequency bands. In at least one example, the frequency bands are categorized into four bands: (i) low band (e.g., about 0 Hz to about 10 Hz, and preferably, about 2.4 Hz to about 4.9 Hz); (ii) mid band (e.g., about 11 Hz to about 300 Hz, and preferably, about 30 Hz to about 130 Hz); (iii) mid-high band (e.g., about 301 Hz to about 1035 Hz, and preferably, about 490 Hz to about 1035 Hz); and (v) high band (e.g., about 1036 Hz to about 5,000 Hz, and preferably, about 1036 Hz to about 4990 Hz).

Particularly, through extensive trials and evaluations, it has been unexpectedly determined that these frequency bands represent the relevant ranges for assessing acoustic activity in downhole wells and are the most effective for distinguishing between different types of downhole events. Further, focusing on these predefined bins not only improves accuracy but also decreases the amount of data that must be processed. This can assist in real time or near real time applications.

In view of this, and depending on the target event, it is expected that the event will exhibit increased frequency response in one or more of the predefined bands. For example, it has been determined that gas leaks commonly produce a frequency response in the mid band, while the mid-high and high bands remain largely inactive. By contrast, operation of ESP and gas-lift systems typically produces stronger responses across the mid, mid-high, and high bands, with particularly pronounced activity in the mid and mid-high bands. Accordingly, the acoustic signature may broadly indicate a higher frequency response in some bands over other bands for certain acoustic events.

Therefore, for a given acoustic event, the associated frequency-based acoustic signature may indicate: (i) the presence of a frequency response within one or more specified frequency bands, including a frequency response that persists over time (e.g., FIGS. 6A-6B); and/or (ii) the absence of a frequency response within one or more frequency bands, including a frequency response that does not meaningfully appear over time.

In some cases, the determination of the presence or absence of a frequency response over time in a given frequency band is made by calculating the spectral energy in that band across successive time instances and determining whether the accumulated or averaged spectral energy exceeds a predefined minimum.

In at least one implementation, the system memory can store predefined reference data associating different target acoustic events with different reference acoustic signatures. It is possible that an event is associated with a single reference acoustic signature, or a combination of acoustic signatures.

At 306b, the raw signal-response data and/or the optical-signal properties determined at 306a are analyzed to assess whether the associated acoustic signatures are present.

For example, the reference acoustic signatures (for the target event) are compared to the identified optical-signal properties, which may include time-domain and frequency-domain characteristics, at various depths to identify the occurrence of the target acoustic event. Depending on the nature of the acoustic signature, the comparison may be performed at a single time instance or over multiple time instances using cumulative or overlaid data.

In at least one example, at 306a (method 300a), the system may monitor or determine only those optical-signal properties that are pertinent to the target acoustic event being evaluated. In this way, the system does not analyze all possible optical-signal properties at 306a, but instead focuses solely on predefined optical-signal properties requiring comparison to the associated acoustic signatures. By limiting analysis to predefined event-relevant properties, the system can reduce computational load and improve detection accuracy.

At 308b, based on the analysis, the system can identify the acoustic event occurring, e.g., at a given depth in the well. In some cases, the system can also determine additional related properties, including the intensity of the event. For example, intensity may be inferred from the magnitude of the relevant optical-signal properties, such as the peak amplitude or energy of the backscattered response. In other implementations, the system may also estimate the spatial extent of the activity by evaluating the number of adjacent channels that exhibit the acoustic signature.

Accordingly, the method for automated event detection reduces the need for manual time-consuming interpretation of data by an operator.

### V. Example Applications

Although the disclosed systems are primarily described in the context of downhole well operations, the same underlying principles can be applied in a wide range of other settings. In particular, the use of a DAS system 112 to generate real-time data (e.g., visualizations) and to perform automated acoustic-event detection can be extended to numerous additional applications. Non-limiting examples include acoustic monitoring for equipment-erosion-related leaks in oil sands operations, leak detection in above-ground pipelines, and production monitoring tasks such as inflow profiling and flow allocation.

### VI. Hardware Configuration of Server

FIG. 8 illustrates an example hardware configuration for an example server 104. However, the same architecture can apply to any other computing device described herein.

As shown, the server 104 can include a processor 802 coupled to one or more of a memory 804, display interface 806 and a communication interface 808.

Processor 802 comprises one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors

Memory 804 refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

It is understood that reference to the processor 802 performing a specific operation or function indicates that the processor 802 is executing instructions stored on memory 804.

Display interface 806 comprises any interface (e.g., LCD screen) for displaying outputs and other data.

Communication interface 806 is any interface (e.g., an antenna) allow for communication over a network, such as network 150.

### VII. Interpretation

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method for using distributed acoustic sensing (DAS) for event monitoring in a downhole well, the method comprising:
analyzing at least one backscattered optical signal generated by a DAS system, to determine at least one optical-signal property,
wherein the at least one backscattered optical signal is generated in response to at least one interrogating optical signal transmitted through a fiber-optic cable extending within the downhole well;
identifying, based on the at least one optical-signal property, the occurrence of an acoustic event within the downhole well at a given depth location; and
generating an output associated with the acoustic event.

2. The method of claim 1, wherein the method is performed in real time or near real time.

3. The method of claim 1, wherein the fiber-optic cable extends along a casing structure extending into the downhole well.

4. The method of claim 1, wherein the at least one optical-signal property comprises at least one time-domain optical-signal property and/or at least one frequency-domain optical-signal property, which is associated with the backscattered optical signal.

5. The method of claim 4, further comprising:
determining a target acoustic event for monitoring;
identifying at least one reference acoustic signature associated with the target acoustic event;
analyzing the at least one optical-signal property at different depths in the downhole well to determine the presence of the at least one reference acoustic signature; and
if the at least one reference acoustic signature is identified at a given depth, generating a corresponding output of the presence of the acoustic event at that depth.

6. The method of claim 5, wherein the backscattered optical signal is analyzed for predefined optical-signal properties, associated with the acoustic event, and the method further comprises:
comparing the predefined optical-signal properties to a corresponding at least one reference acoustic signature.

7. The method of claim 5, wherein the at least one reference acoustic signature for a given event comprises (i) at least one reference time-domain optical-signal property, and/or (ii) at least one reference frequency-domain optical-signal property, indicative of the acoustic event.

8. The method of claim 7, wherein the reference frequency-domain optical-signal property comprises a frequency response in at least one frequency band comprising: (i) a low-band frequency range, (ii) a mid-based frequency range, (iii) a mid-high-band frequency range, and (iv) a high-band frequency range.

9. The method of claim 8, wherein the at least one frequency band comprises, (i) the low-band frequency range from about 0 Hz to about 10 Hz, and preferably, about 2.4 Hz to about 4.9 Hz; (ii) the mid-band frequency range from about 11 Hz to about 300 Hz, and preferably, about 30 Hz to about 130 Hz; (iii) the mid-band frequency range from about 301 Hz to about 1035 Hz, and preferably, about 490 Hz to about 1035 Hz; and (iv) the high-band frequency range from about 1036 Hz to about 5000 Hz, and preferably, about 1036 Hz to about 4990 Hz.

10. The method of claim 8, wherein the target acoustic event comprises surface casing vent flow (SCVF) and/or gas migration, and the event demonstrates higher frequency responses in the mid-band, than the mid-high and high-bands.

11. A system for distributed acoustic sensing (DAS)-based acoustic event monitoring in a downhole well, the system comprising:
a fiber-optic cable configured to be deployed within the downhole well;
an DAS unit configured to transmit the at least one interrogating optical signal through the fiber-optic cable and to receive at least one backscattered optical signal generated in response thereto; and
a memory storing computer-executable instructions which, when executed by at least one processor, cause the at least one processor to execute the method comprising:
analyzing the at least one backscattered optical signal generated by a DAS unit, to determine at least one optical-signal property;
identifying, based on the at least one optical-signal property, the occurrence of an acoustic event within the downhole well at a given depth location; and
generating an output associated with the acoustic event.

12. The system of claim 11, wherein the method is performed in real time or near real time.

13. The system of claim 11, wherein the fiber-optic cable extends along a casing structure extending into the downhole well.

14. The system of claim 11, wherein the at least one optical-signal property comprises at least one time-domain optical-signal property and/or at least one frequency-domain optical-signal property, which is associated with the backscattered optical signal.

15. The system of claim 14, wherein the method further comprises:
determining a target acoustic event for monitoring;
identifying at least one reference acoustic signature associated with the target acoustic event;
analyzing the at least one optical-signal property at different depths in the downhole well to determine the presence of the at least one reference acoustic signature; and
if the at least one reference acoustic signature is identified at a given depth, generating a corresponding output of the presence of the acoustic event at that depth.

16. The system of claim 15, wherein the backscattered optical signal is analyzed for predefined optical-signal properties, associated with the acoustic event, and the method further comprises:
comparing the predefined optical-signal properties to a corresponding at least one reference acoustic signature.

17. The system of claim 15, wherein the at least one reference acoustic signature for a given event comprises (i) at least one reference time-domain optical-signal property, and/or (ii) at least one reference frequency-domain optical-signal property, indicative of the acoustic event.

18. The system of claim 17, wherein the reference frequency-domain optical-signal property comprises a frequency response in at least one frequency band comprising: (i) a low-band frequency range, (ii) a mid-based frequency range, (iii) a mid-high-band frequency range, and (iv) a high-band frequency range.

19. The system of claim 18, wherein the at least one frequency band comprises, (i) the low-band frequency range from about 0 Hz to about 10 Hz, and preferably, about 2.4 Hz to about 4.9 Hz; (ii) the mid-band frequency range from about 11 Hz to about 300 Hz, and preferably, about 30 Hz to about 130 Hz; (iii) the mid-band frequency range from about 301 Hz to about 1035 Hz, and preferably, about 490 Hz to about 1035 Hz; and (iv) the high-band frequency range from about 1036 Hz to about 5000 Hz, and preferably, about 1036 Hz to about 4990 Hz.

20. The system of claim 18, wherein the target acoustic event comprises surface casing vent flow (SCVF) and/or gas migration, and the event demonstrates higher frequency responses in the mid-band, than the mid-high and high-bands.
